(19) United States
(12) Patent Application Publication
(10) Pub. No.: US 2025/0239394 A1
(43) Pub. Date: Jul. 24, 2025

(54) VERTICALLY-WOUND COUPLING INDUCTOR AND METHOD FOR FABRICATING THE SAME

(71) Applicant: CHILISIN ELECTRONICS CORP., TAOYUAN CITY (TW)

(72) Inventors: SHU-PU YANG, TAOYUAN CITY (TW); SHOU-YI TSAO, TAOYUAN CITY (TW); WEN-HUI CHANG, TAOYUAN CITY (TW); SHENG-CHIH LIN, TAOYUAN CITY (TW)

(21) Appl. No.: 18/965,049

(22) Filed: Dec. 2, 2024

(30) Foreign Application Priority Data
Jan. 22, 2024 (TW) 113102363

(51) Int. Cl. H01F 27/29; H01F 27/32; H01F 41/12

(52) U.S. Cl. CPC H01F 27/292; H01F 27/327; H01F 41/127

(57) ABSTRACT

A vertically-wound coupling inductor and a method for fabricating the same are provided. The vertically-wound coupling inductor includes an inductor body, a first coil part, a second coil part, a first external electrode, a second external electrode, and an intermediate layer. The first coil part and the second coil part are oppositely disposed in the inductor body, and the first coil part and the second coil part has a first gap therebetween. The first external electrode and the second external electrode are disposed on an outer surface of the inductor body, the first external electrode is connected to the first coil part, and the second external electrode is connected to the second coil part. The intermediate layer is disposed in the inductor body and located in the first gap.

### CROSS-REFERENCE TO RELATED PATENT APPLICATION

This application claims the benefit of priority to Taiwan Patent Application No. 113102363, filed on Jan. 22, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an inductor and a method for fabricating the same, and more particularly to a vertically-wound coupling inductor and a method for fabricating the same.

### BACKGROUND OF THE DISCLOSURE

Existing coupling inductors are mainly based on a conventional horizontally-wound double coil structure, in which a direction of the magnetic field line is perpendicular to a direction of an electrode. Thus, magnetic field interference issues may occur in practical applications.

Therefore, how to reduce the magnetic field interference issue and overcome the above-mentioned defects through improvements in structural design has become one of the important issues to be addressed in this industry.

### SUMMARY OF THE DISCLOSURE

In response to the above-referenced technical inadequacies, the present disclosure provides a vertically-wound coupling inductor and a method for fabricating the vertically-wound coupling inductor that are capable of reducing the magnetic field interference issue.

In order to solve the above-mentioned problems, one of the technical aspects adopted by the present disclosure is to provide a vertically-wound coupling inductor. The vertically-wound coupling inductor includes an inductor body, a first coil part, a second coil part, a first external electrode, a second external electrode, and an intermediate layer. The first coil part and the second coil part are oppositely disposed in the inductor body, and the first coil part and the second coil part has a first gap therebetween. The first external electrode and the second external electrode are disposed on an outer surface of the inductor body, the first external electrode is connected to the first coil part, and the second external electrode is connected to the second coil part. The intermediate layer is disposed in the inductor body and located in the first gap. A direction of a central magnetic field line generated by the magnetic coupling of the first coil part and the second coil part is parallel to an arrangement direction of the first external electrode and the second external electrode.

In order to solve the above-mentioned problems, another one of the technical aspects adopted by the present disclosure is to provide a method for fabricating a vertically-wound coupling inductor. The method includes the following steps. A yellow photolithography process is performed to form a first coil part and a second coil part. A first pressing process is performed to form an intermediate layer. The first coil part and the second coil part are disposed oppositely on two sides of the intermediate layer, so that the first coil part and the second coil part have a first gap therebetween. The first coil part, the second coil part, and the intermediate layer are placed into a mold, and the mold is filled with a first magnetic material to form an inductor body by performing a second pressing process. A cutting process is performed on the inductor body to expose portions of the first coil part and the second coil part. An electroplating process is performed to form a first external electrode and a second external electrode on an outer surface of the inductor body. The first external electrode is connected to the first coil part, and the second external electrode is connected to the second coil part. A direction of a central magnetic field line generated by the magnetic coupling of the first coil part and the second coil part is parallel to an arrangement direction of the first external electrode and the second external electrode.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a vertically-wound coupling inductor according to one embodiment of the present disclosure;

FIG. 2 is a schematic side view of the vertically-wound coupling inductor according to one embodiment of the present disclosure;

FIG. 3 is a schematic front view of the vertically-wound coupling inductor according to one embodiment of the present disclosure;

FIG. 4 is a schematic top view of one of coil patterns of a first coil part according to one embodiment of the present disclosure;

FIG. 5 is a schematic top view of another one of the coil patterns of the first coil part according to one embodiment of the present disclosure;

FIG. 6 is a schematic top view of a spacer of the first coil part according to one embodiment of the present disclosure;

FIG. 7 is a curve chart showing a coupling coefficient versus a thickness of an intermediate layer when the vertically-wound coupling inductor adopts magnetic materials or inorganic materials according to one embodiment of the present disclosure;

FIG. 8 is a schematic top view of the intermediate layer having an opening according to one embodiment of the present disclosure;

FIG. 9 is a curve chart showing a coupling coefficient versus the thickness of the intermediate layer when the vertically-wound coupling inductor adopts inorganic materials and has the opening according to one embodiment of the present disclosure;

FIG. 10 is a schematic diagram of a distribution of magnetic lines of force of the vertically-wound coupling inductor according to one embodiment of the present disclosure;

FIG. 11 is a flowchart of a method for fabricating the vertically-wound coupling inductor according to one embodiment of the present disclosure;

FIG. 12 is a schematic diagram of forming a predetermined pattern layer in step S10;

FIG. 13 is a schematic diagram of forming a coil part to be formed on the predetermined pattern layer in step S10;

FIG. 14 is a schematic diagram of performing a pressing process to form the spacer in step S10;

FIG. 15 is a schematic diagram of performing the pressing process to form an inductor body in steps S12 and S13;

FIG. 16 is a schematic diagram of performing a cutting process to form the inductor body in step S14; and

FIG. 17 is a schematic diagram of performing an electroplating process to form a first external electrode and a second external electrode in step S15.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

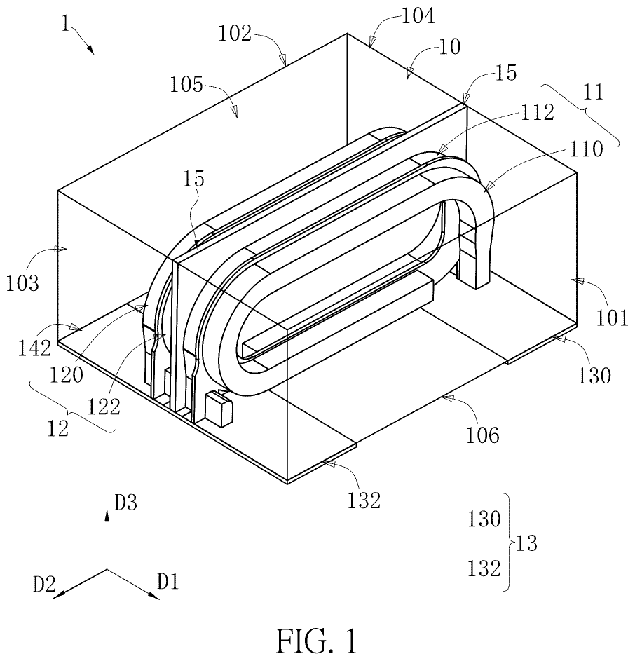

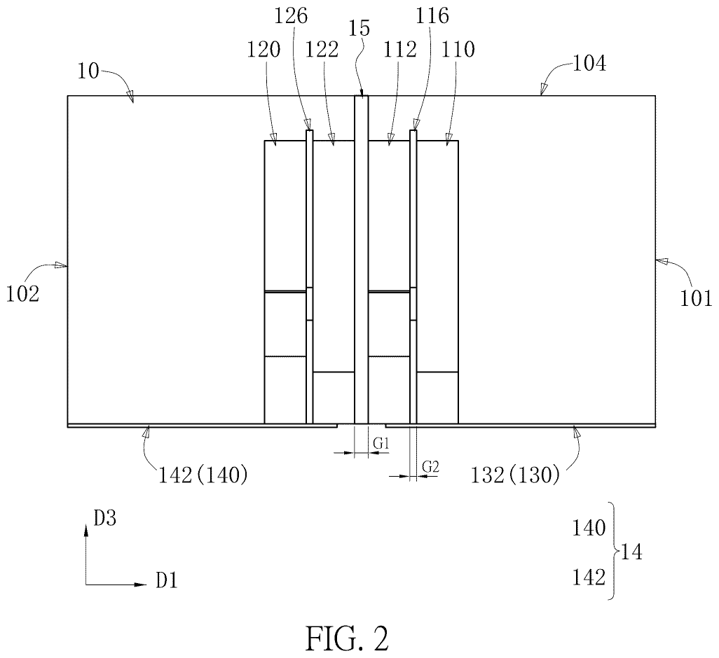

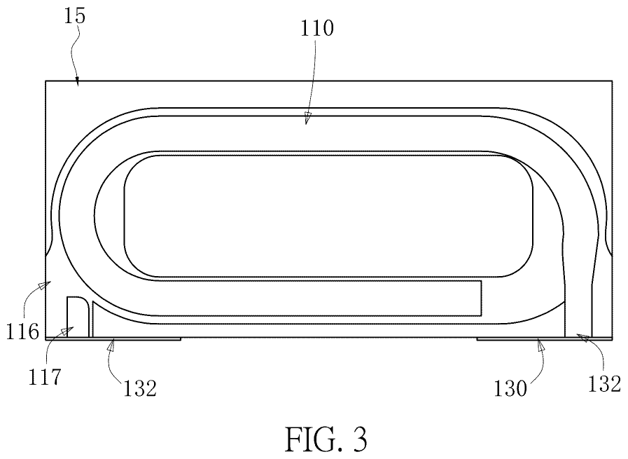

FIG. 1 is a schematic perspective view of a vertically-wound coupling inductor according to one embodiment of the present disclosure. FIG. 2 is a schematic side view of the vertically-wound coupling inductor according to one embodiment of the present disclosure. FIG. 3 is a schematic front view of the vertically-wound coupling inductor according to one embodiment of the present disclosure.

Referring to FIG. 1 to FIG. 3, one embodiment of the present disclosure provides a vertically-wound coupling inductor 1 that includes an inductor body 10, a first coil part 11, a second coil part 12, a first external electrode 13, a second external electrode 14, and an intermediate layer 15.

The inductor body 10 may be formed to have an appearance as shown in FIG. 1 to FIG. 3, and the first coil part 11 and the second coil part 12 may be oppositely disposed in the inductor body 10. The inductor body 10 may be, for example, a hexahedron having a first surface 101 and a second surface 102 facing each other in a first direction D1, a third surface 103 and a fourth surface 104 facing each other in a second direction D2, and a fifth surface 105 and a sixth surface 106 facing each other in a third direction D3. When the vertically-wound coupling inductor 1 is mounted on a printed circuit board, the sixth surface 106 of the inductor body 10 can be used as a mounting surface.

The inductor body 10 may include magnetic materials and adhesive materials. Specifically, the inductor body 10 can be formed by filling a mold with magnetic powder made of the magnetic material and other components of the vertically-wound coupling inductor 1 and then pressing the materials. In order to clearly display an internal structure of the vertically-wound coupling inductor 1, the inductor body 10 is depicted to be transparent in FIG. 1 and is omitted in FIG. 2 and FIG. 3.

It should be noted that, in order to enable the first coil part 11 and the second coil part 12 to form magnetic coupling, a first gap G1 is provided between the first coil part 11 and the second coil part 12. An inductance of the vertically-wound coupling inductor 1 can be adjusted by controlling a size of the first gap G1. The first coil part 11 may be, for example, a coil composed of a plurality of metal rings having a certain thickness, and the metal rings are stacked along the first direction D1. For example, the first coil part 11 may include a coil pattern 110 and a coil pattern 112 arranged along the first direction D1; similar to the first coil part 11, the second coil part 12 may include a coil pattern 120 and a coil pattern 122 arranged along the first direction D1.

The first external electrode 13 and the second external electrode 14 are arranged on an outer surface of the inductor body 10. The first external electrode 13 is connected to the first coil part 11 and the second external electrode 14 is connected to the second coil part 12; since the first external electrode 13 and the second external electrode 14 are arranged in parallel along the first direction D1, the first direction D1 is hereinafter referred to as an arrangement direction of the first external electrode 13 and the second external electrode 14. In detail, the first external electrode 13 may include an electrode plate 130 and an electrode plate 132 spaced apart along the second direction D2, and the second external electrode 14 may include an electrode plate 140 and an electrode plate 142 spaced apart along the second direction D2.

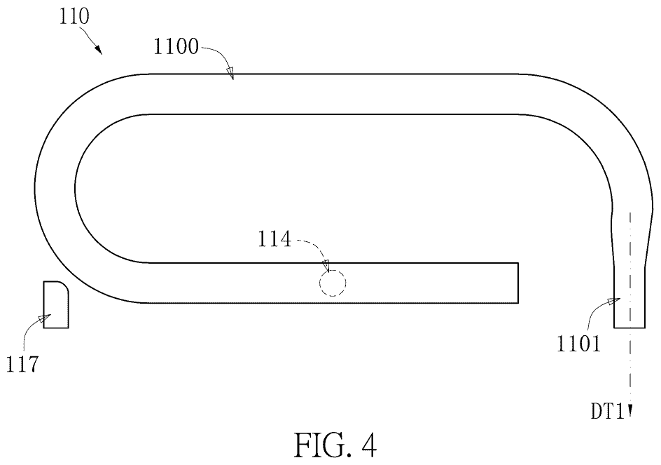

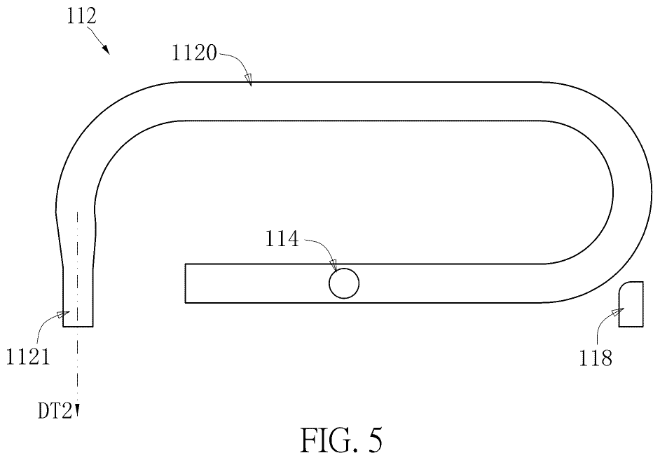

FIG. 4 is a schematic top view of one of coil patterns of a first coil part according to one embodiment of the present disclosure, and FIG. 5 is a schematic top view of another one of the coil patterns of the first coil part according to one embodiment of the present disclosure. Referring to FIG. 1 and FIG. 4, the coil pattern 110 is a semi-closed ring body 1100 having an opening facing the sixth surface 106. A connection pattern 1101 extends along a tangential direction DT1 formed by a first end of the semi-closed ring body 1100, and connects the first end of the semi-closed ring body 1100 to the electrode plate 130. Specifically, one end of the connection pattern 1101 used to connect the electrode plate 130 can be exposed to the sixth surface 106 of the inductor body 10, such that the coil pattern 110 can be electrically connected to the electrode plate 130 through the connection pattern 1101. In this embodiment, the semi-closed ring body 1100 may be, for example, a semi-closed elliptical, but the present disclosure is not limited thereto.

On the other hand, reference is made to FIG. 5. The coil pattern 112 is another semi-closed ring body 1120 that also has an opening facing the sixth surface 106, but the opening of the semi-closed ring body 1100 is located on a different side of the inductor body 10. A connection pattern 1121 extends along a tangential direction DT2 formed by a second end of the semi-closed ring body 1120 and connects the second end of the semi-closed ring body 1120 to the electrode plate 132. One end of the connection pattern 1121 used to connect the electrode plate 132 can be exposed to the sixth surface 106 of the inductor body 10, such that the coil pattern 112 can be electrically connected to the electrode plate 132 through the connection pattern 1121. In this embodiment, the semi-closed ring body 1120 may be, for example, semi-closed elliptical and symmetrical to the semi-closed ring body 1100, but the present disclosure is not limited thereto.

It should be noted that the tangential direction DT1 is parallel to the tangential direction DT2, and both the tangential direction DT1 and the tangential direction DT2 are perpendicular to the outer surface of the inductor body 10, specifically the sixth surface 106. In addition, the coil pattern 110 and the coil pattern 112 are arranged opposite to each other and separated by a second gap G2. In this case, the first coil part 11 may further include a connection part 114 disposed in the second gap G2 to connect the coil pattern 110 to the coil pattern 112.

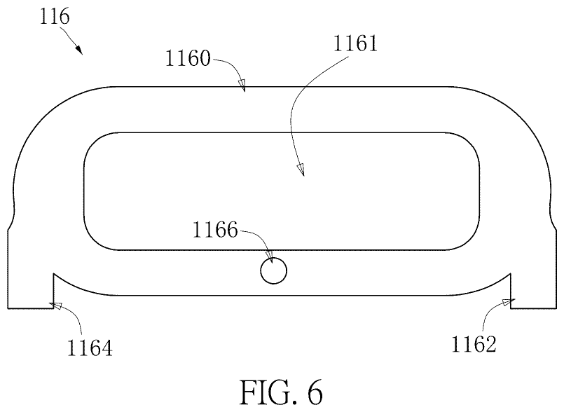

FIG. 6 is a schematic top view of a spacer of the first coil part according to one embodiment of the present disclosure. Referring to FIG. 6, the first coil part 11 further includes a spacer 116 that is in parallel with the coil pattern 110 and the coil pattern 112 along the first direction D1 and is disposed in the second gap G2 to adjust inductance characteristics (for example, a sensitivity) of the first coil part 11. The spacer 116 is a plate body and has a thickness corresponding to the second gap G2. In appearance, the spacer 116 has a closed ring body 1160 similar to the semi-closed ring body 1100 and the semi-closed ring body 1120. A center of the closed ring body 1160 has a hollow portion 1161, and an area of the closed ring body 1160 in the first direction D1 can completely cover the semi-closed ring body 1100 and the semi-closed ring body 1120. In this embodiment, the hollow portion 1161 may be, for example, a rounded rectangle, but the present disclosure is not limited thereto. In addition, the closed ring body 1160 is also connected to the electrode plates 130 and 132 through extension parts 1162 and 1164, respectively. The extension part 1162 extends along the tangential direction DT1 and adheres to the connection pattern 1101, and the extension part 1164 extends along the tangential direction DT2 and adheres to the connection pattern 1121, thereby strengthening structural strength of the first coil part 11 to prevent the first coil part 11 from being subjected to external force during the fabrication process and sustaining structural collapse or damage.

In addition, reference is further made to FIG. 4 and FIG. 5. The first coil part 11 may further include a stabilizer 117 provided on the same layer as the coil pattern 110 and a stabilizer 118 provided on the same layer as the coil pattern 112. The stabilizer 117 is not directly connected to the coil pattern 110 and is provided on a side of the semi-closed ring body 1100 that does not have an opening to simultaneously contact the electrode plate 132 and the extension part 1164 of the spacer 116, thereby providing a supporting force for the spacer 116 in the first direction D1 to enhance the structural strength of the spacer 116 at a position of the extension part 1164.

Similarly, the stabilizer 118 is not directly connected to the coil pattern 112 and is provided on a side of the semi-closed ring body 1120 that does not have an opening to simultaneously contact the electrode plate 130 and the extension part 1162 of the spacer 116, thereby providing a supporting force for the spacer 116 in the first direction D1 to enhance the structural strength of the spacer 116 at a position of the extension part 1162. In addition, the spacer 116 further has an opening 1166 corresponding to the connection part 114, and the opening 1166 allows the connection part 114 to pass therethrough to connect the coil pattern 110 and the coil pattern 112, such that the coil pattern 110 and the coil pattern 112 can form a continuous coil structure.

On the other hand, similar to the first coil part 11, the second coil part 12 may include a coil pattern 120, a coil pattern 122, and a spacer 126 arranged along the first direction D1, and specific configurations thereof are the same as that of the coil pattern 110, the coil pattern 112, and the spacers 116. The coil pattern 110, the coil pattern 112, and the spacers 116 are only symmetric to the coil pattern 120, the coil pattern 122, and the spacer 126; thus, details will not be reiterated in detail herein.

Reference is further made to FIG. 1 to FIG. 3, and the intermediate layer 15 is disposed in the inductor body 10 and located in the first gap G1. The intermediate layer 15 can be, for example, a plate as shown in the figure, and can be made of organic materials or inorganic materials. The intermediate layer 15 can include at least one of a material containing oxygen and silicon functional groups (such as silicon dioxide), copper clad laminate (CCL), epoxy resin, polyimide (PI), fiberglass materials, and ceramic materials, etc.

In other embodiments, the inductor body 10, the intermediate layer 15, and the spacers 116, 126 are all made of magnetic materials, but the magnetic materials used by the three components are different. Different magnetic materials can be used to manufacture the intermediate layer 15; For example, a magnetic permeability of the magnetic material used in the intermediate layer 15 may be lower than a magnetic permeability of the magnetic material used in the spacers 116, 126. The low magnetic permeability material used in the intermediate layer 15 can be, for example, an alloy material having a particle size distribution D50 (the particle size corresponding to when the cumulative particle size distribution percentage reaches 50%) less than 10 μm, such as iron (Fe), silicon (Si), chromium (Cr), nickel (Ni), aluminum (Al), iron-nickel alloy (FeNi), iron silicon chromium alloy (FeSiCr), amorphous conductor materials, nanocrystals, etc., and the spacers 116 and 126 on two sides of the intermediate layer 15 can be made of magnetic materials having relatively high magnetic permeability such as carbon-based iron powder or alloy materials with a particle size distribution D50 of 10 μm or greater. That is to say, the magnetic permeability and particle size of the magnetic material used in the intermediate layer 15 are relatively smaller than the magnetic materials used in the spacers 116 and 126.

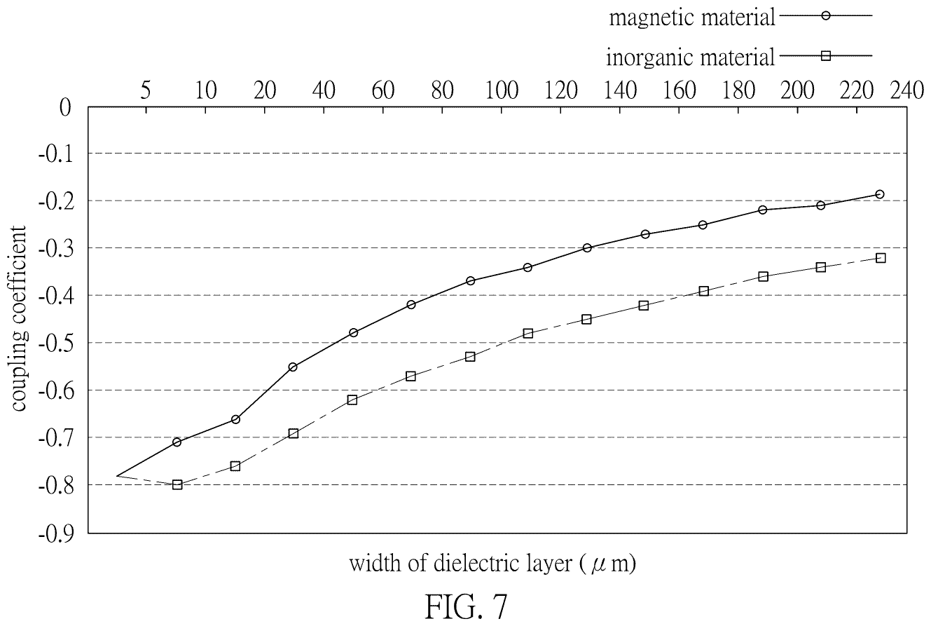

Referring to FIG. 7, FIG. 7 is a curve chart showing a coupling coefficient versus a thickness of an intermediate layer when the vertically-wound coupling inductor adopts magnetic materials or inorganic materials according to one embodiment of the present disclosure. The coupling coefficient represents the degree of coupling between the first coil part 11 and the second coil part 12 when mutual inductance occurs. The closer the coupling coefficient to 1 is, the better the degree of coupling becomes. As shown in FIG. 7, when the intermediate layer 15 is made of an inorganic material and has a thickness is in a range of from 10 μm to 260 μm, the coupling coefficient that is obtained is approximately in the range of from −0.3 to −0.8; when the intermediate layer 15 is made of a magnetic material and has a thickness is in a range of from 10 μm to 140 μm, the coupling coefficient that is obtained is approximately in the range of from −0.3 to −0.8. In other words, regardless of the intermediate layer 15 being made of magnetic materials or inorganic materials, the vertically-wound coupling inductor 1 of this embodiment of the present disclosure can have a certain degree of coupling coefficient, thereby allowing a user to arbitrarily determine the size of the coupling coefficient and the corresponding thickness of the intermediate layer 15 according to cost considerations or size requirements.

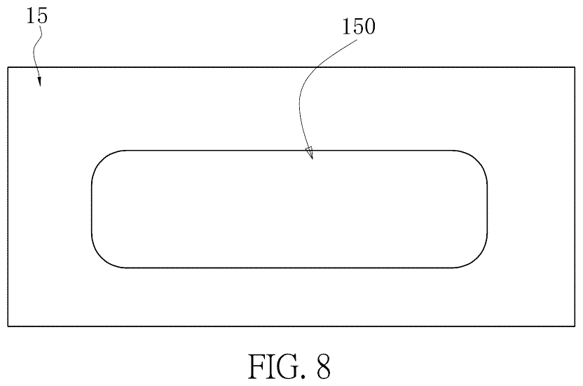

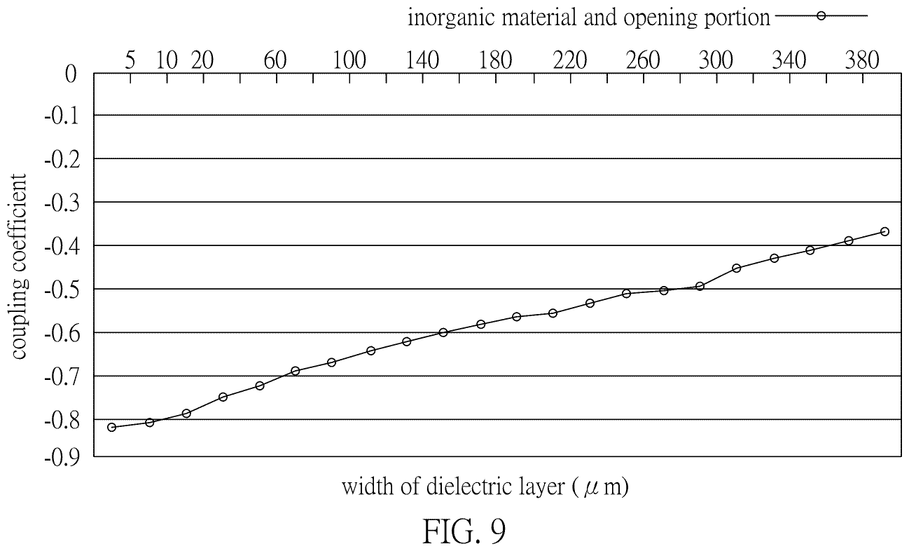

Reference is made to FIG. 8 and FIG. 9, FIG. 8 is a schematic top view of the intermediate layer having an opening according to one embodiment of the present disclosure, and FIG. 9 is a curve chart showing a coupling coefficient versus the thickness of the intermediate layer when the vertically-wound coupling inductor adopts inorganic materials and has the opening according to one embodiment of the present disclosure. In other embodiments in which the intermediate layer 15 is made of an inorganic material, the intermediate layer 15 can further include an opening portion 150 corresponding to the hollow portion 1161 in the center of the closed ring body 1160, and also corresponding to the hollow portion 1161 in shape (for example, the opening portion 150 can be a rounded rectangle). As shown in FIG. 9, when the opening portion 150 is formed and a thickness thereof is in the range of from 20 μm to 480 μm, the coupling coefficient that is obtained is approximately in the range of from −0.3 to −0.8. That is to say, after the opening portion 150 is formed in the intermediate layer 15, the coupling coefficient of the vertically-wound coupling inductor 1 can be further adjusted to be from −0.78 to −0.8 when the vertically-wound coupling inductor 1 has the same thickness of 20 μm, thereby increasing the degree of coupling between the first coil part 11 and the second coil part 12 when mutual inductance occurs.

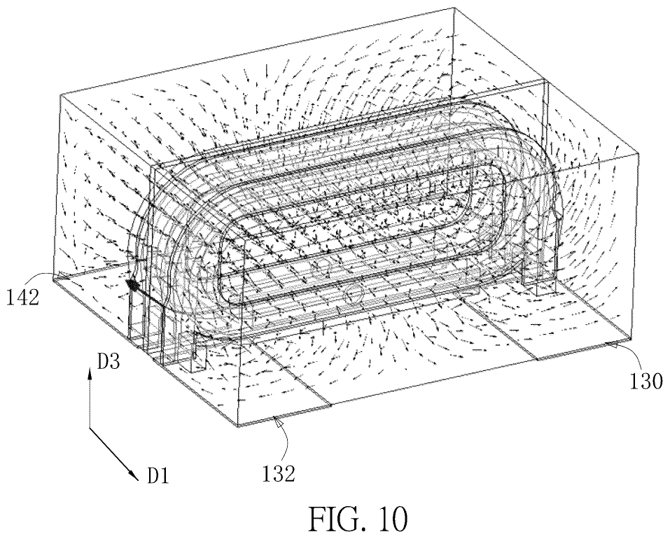

FIG. 10 is a schematic diagram of a distribution of magnetic lines of force of the vertically-wound coupling inductor according to one embodiment of the present disclosure. As shown in FIG. 10, when the vertically-wound coupling inductor 1 is energized, the first coil part 11 and the second coil part 12 will generate magnetic lines of force (referred to as central magnetic lines of force) in a center of the coil through magnetic coupling, and directions of the central magnetic lines of force are parallel with an arrangement direction (i.e., the first direction D1) of the first external electrode 13 and the second external electrode 14. Comparing with the case where the magnetic lines of force are perpendicular to the arrangement direction of the electrode in conventional inductors, since the magnetic lines of force are parallel to the arrangement direction of the electrodes, the magnetic lines of force generated by a current along the third direction D3 at the electrode can improve the cases where the vertically-wound coupling inductors are interfered with during applications.

It should be noted that, in the above-mentioned embodiments, each of the first external electrode 13 and the second external electrode 14 includes two plates, and is only provided on the sixth surface 106 of the inductor body 10 (i.e., a bottom of the inductor body 10); however, the present disclosure is not limited thereto. The first external electrode 13 and the second external electrode 14 can also protrude out from lateral sides of the inductor body 10. For example, the electrode plates 130, 132, 140, and 142 can be designed as L-shaped plates, such that the first external electrode 13 and the second external electrode 14 can protrude out from the first surface 101, the second surface 102, the third surface 103, and the fourth surface 104, and provide electrical contacts for connection to external circuits.

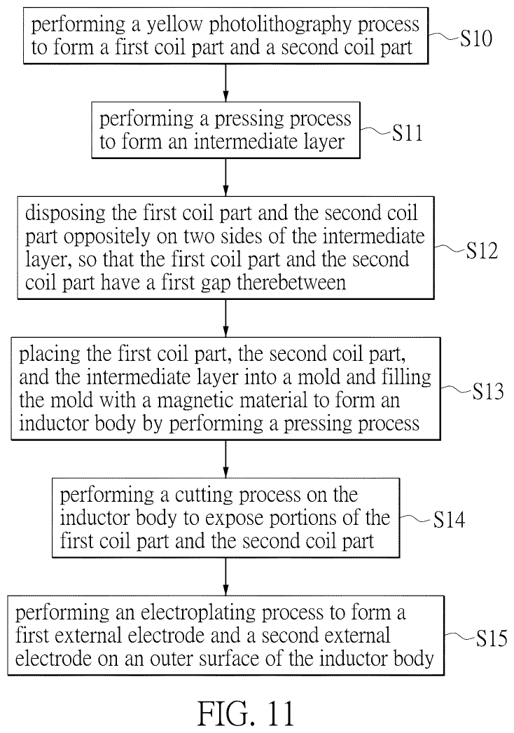

Referring to FIG. 11, FIG. 11 is a flowchart of a method for fabricating the vertically-wound coupling inductor according to one embodiment of the present disclosure. In one embodiment of the present disclosure, a method for fabricating a vertically-wound coupling inductor is further provided to manufacture a vertically-wound coupling inductor 1 as shown in FIG. 1. The method includes the following steps.

Step S10 includes: executing a yellow photolithography process to form a first coil part and a second coil part.

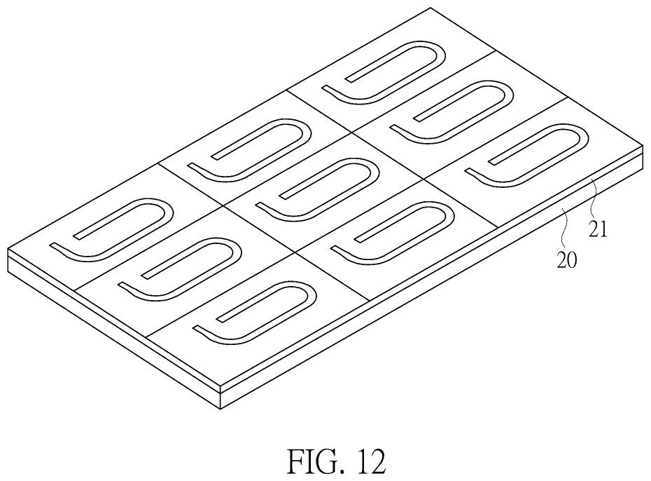

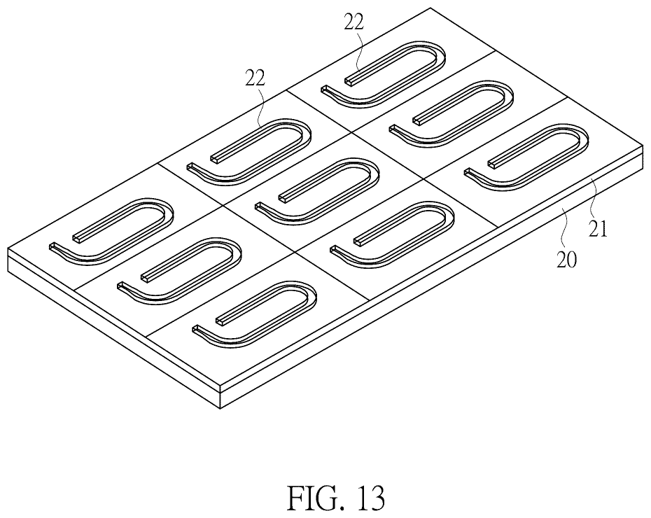

FIG. 12 is a schematic diagram of forming a predetermined pattern layer in step S10. FIG. 13 is a schematic diagram of forming a coil part to be formed on the predetermined pattern layer in step S10. As shown in FIG. 12 and FIG. 13, in step S10, a lithography process can be performed on a substrate 20 to form a predetermined pattern layer 21. The predetermined pattern layer 21 defines patterns corresponding to the coil patterns 110, 112, 120, and 122. Then, a coil part to be formed 22 can be formed on the predetermined pattern layer 21 through a deposition process; and finally, the substrate 20 and the predetermined pattern layer 21 can be removed through an etching process to form the first coil part 11 and the second coil part 12 described in the above-mentioned embodiments.

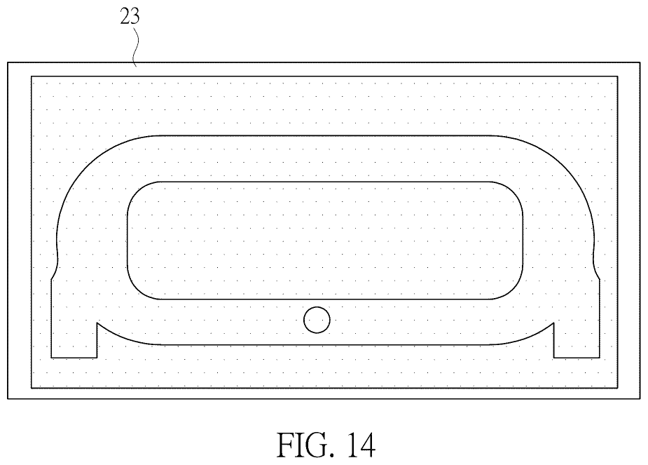

FIG. 14 is a schematic diagram of performing a pressing process to form the spacer in step S10. As shown in FIG. 14, the pressing process can be performed. After filling corresponding magnetic powder (such as the aforementioned magnetic material having higher magnetic permeability) into a mold 23 designed with the shape of the spacer 116, the spacer 116 disposed in the second gap G2 is formed by hot pressing. After the spacer 116 is formed, the spacer 116 can be combined with the coil patterns 110 and 112 formed in step S10 to form the first coil part 11, and the second coil part 12 can also be formed in a similar manner, which will not be reiterated herein.

The method proceeds to step S11, and step S11 includes: performing a pressing process to form an intermediate layer.

In this step, similar to a manner in which the spacer 116 is formed, corresponding magnetic powder (such as the aforementioned magnetic material having lower magnetic permeability) can be filled into a mold, and then the intermediate layer 15 for being placed in the first gap G1 is formed by hot pressing.

Step S12 includes: disposing the first coil part and the second coil part oppositely on two sides of the intermediate layer, so that the first coil part and the second coil part have a first gap therebetween.

Step S13 includes: placing the first coil part, the second coil part, and the intermediate layer into a mold and filling the mold with a magnetic material to form an inductor body by performing a pressing process.

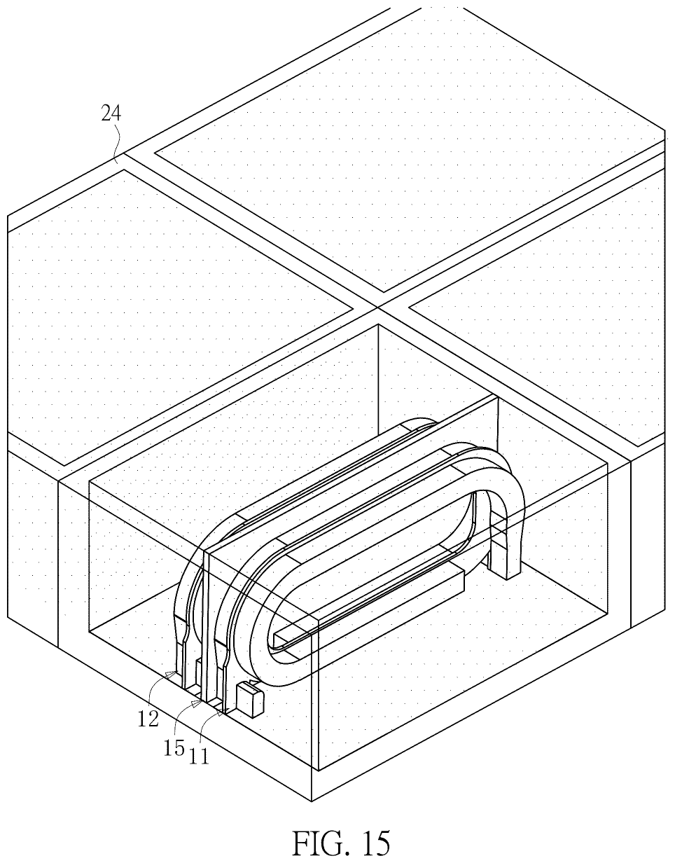

FIG. 15 is a schematic diagram of performing the pressing process to form an inductor body in steps S12 and S13. Referring to FIG. 15, step S12 and step S13 can be performed simultaneously. The first coil part 11, the second coil part 12, and the intermediate layer 15 are placed into predetermined positions (and can be fixed by the organic material layer) of a mold 24 (which can have multiple cavities for large-scale production). The first coil part 11 and the second coil part 12 can generate the first gap G1 by abutting against the intermediate layer 15 having a predetermined thickness. The magnetic powder is then filled into the mold 24, and finally the inductor body 10 is formed through a hot pressing process.

It should be noted that, in order to successfully form the inductor body 10, the hot pressing process must be performed within a predetermined temperature range and a predetermined pressure range. Preferably, the temperature range is from 100 degrees to 200 degrees Celsius, and the pressure range is from 10 Mpa to 600 Mpa. The component may not be molded if the hot pressing process is performed outside of this temperature range and pressure range.

In addition, since the stabilizers 117 and 118 are used in the aforementioned embodiment to provide support for the spacer 116 in the first direction D1, the structure of the spacer 116 at the extension part 1164 is also strengthened, thereby ensuring that the spacer 116 will not be deformed or displaced during the hot pressing process. On the other hand, in the aforementioned coil patterns 110, 112, 120, and 122, since the connection patterns (such as the connection patterns 1101, 1121) extend along the tangential directions DT1 and DT2 of the semi-closed ring body, a junction between the connection patterns and the semi-closed ring body will have greater structural strength, thereby ensuring that the coil patterns 110, 112, 120, 122 will not be easily deformed or displaced during the hot pressing process.

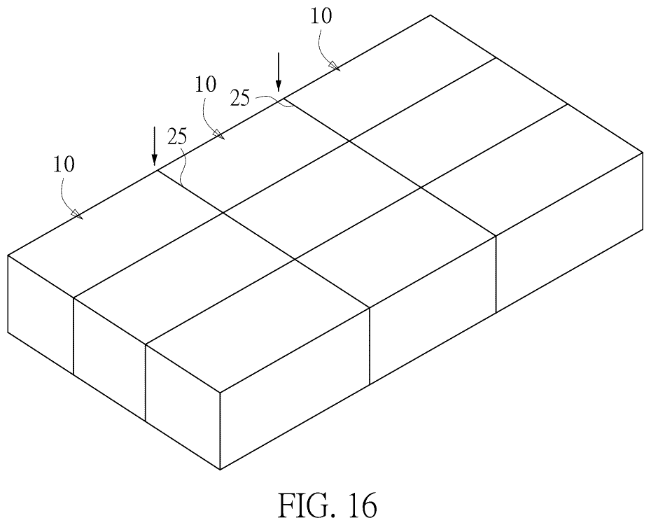

Step S14 includes: performing a cutting process on the inductor body to expose portions of the first coil part and the second coil part. FIG. 16 is a schematic diagram of performing a cutting process to form the inductor body in step S14. As shown in FIG. 16, the inductor body 10 that is pressed can be cut along cutting lines 25; at the same time, portions intended for being connected to the external electrodes are exposed. That is, the portions of the aforementioned connection patterns 1101, 1121 and the stabilizers 117 and 118 facing the sixth surface 106 are exposed.

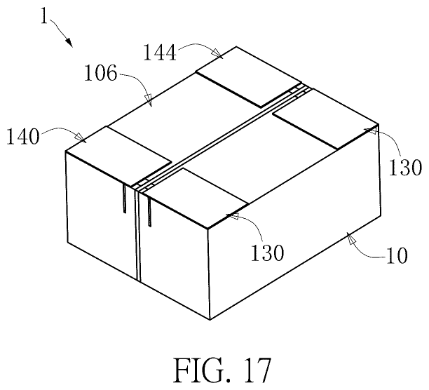

Step S15 includes: performing an electroplating process to form a first external electrode and a second external electrode on an outer surface of the inductor body. FIG. 17 is a schematic diagram of performing an electroplating process to form a first external electrode and a second external electrode in step S15. As shown in FIG. 17, the electrode plates 130, 132 of the first external electrode 13 and the electrode plates 140, 142 of the second external electrode 14 can be formed on the sixth surface 106 to form the vertically-wound coupling inductor 1.

### Beneficial Effects of the Embodiments

One of the beneficial effects of the present disclosure is that, in the vertically-wound coupling inductor and the method for fabricating the vertically-wound coupling inductor provided by the present disclosure, comparing with the case where the magnetic lines of force are perpendicular to the arrangement direction of the electrode in conventional inductors, since the magnetic lines of force are parallel to the arrangement direction of the electrodes, the cases where the vertically-wound coupling inductors are interfered with during applications can be improved.

Furthermore, since the stabilizers are used to provide support for the spacer in the first direction, the structure of the spacer at the extension part is also strengthened, thereby ensuring that the spacer will not be deformed or displaced during the hot pressing process. On the other hand, in the coil patterns, since the connection patterns extend along the tangential directions of the semi-closed ring body, a junction between the connection patterns and the semi-closed ring body will have greater structural strength, thereby ensuring that the coil patterns will not be easily deformed or displaced during the hot pressing process.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A vertically-wound coupling inductor, comprising:
an inductor body;
a first coil part;
a second coil part, wherein the first coil part and the second coil part are oppositely disposed in the inductor body, and the first coil part and the second coil part has a first gap therebetween;
a first external electrode;
a second external electrode, wherein the first external electrode and the second external electrode are disposed on an outer surface of the inductor body, the first external electrode is connected to the first coil part, and the second external electrode is connected to the second coil part; and
an intermediate layer disposed in the inductor body and located in the first gap;
wherein a direction of a central magnetic field line generated by the magnetic coupling of the first coil part and the second coil part is parallel to an arrangement direction of the first external electrode and the second external electrode.

2. The vertically-wound coupling inductor according to claim 1, wherein each of the first external electrode and the second external electrode includes a first electrode plate and a second electrode plate that are spaced apart from each other, and each of the first coil part and the second coil part includes:
a first coil pattern electrically connected to the first electrode plate through a first connection pattern;
a second coil pattern electrically connected to the second electrode plate through a second connection pattern, wherein the first coil pattern and the second coil pattern are oppositely disposed and have a second gap therebetween; and
a first connection part disposed in the second gap and connects the first coil pattern to the second coil pattern.

3. The vertically-wound coupling inductor according to claim 2, wherein the first coil pattern is a first semi-closed ring body, and the first connection pattern extends along a first tangential direction defined at a first end of the first semi-closed ring body to connect the first end to the first electrode plate;
wherein the second coil pattern is a second semi-closed ring body, and the second connection pattern extends along a second tangential direction defined at a second end of the second semi-closed ring body to connect the second end to the second electrode plate.

4. The vertically-wound coupling inductor according to claim 3, wherein the first tangential direction is parallel to the second tangential direction, and the first tangential direction and the second tangential direction are perpendicular to the outer surface of the inductor body.

5. The vertically-wound coupling inductor according to claim 3, wherein each of the first coil part and the second coil part further includes a spacer disposed in the second gap.

6. The vertically-wound coupling inductor according to claim 5, wherein the spacer has a closed ring body similar to the first semi-closed ring body and the second semi-closed ring body.

7. The vertically-wound coupling inductor according to claim 5, wherein the inductor body is made of a first magnetic material, the intermediate layer is made of a second magnetic material, and the spacer is made of a third magnetic material, and wherein the first magnetic material, the second magnetic material, and the third magnetic material are different from each other.

8. The vertically-wound coupling inductor according to claim 7, wherein a magnetic permeability of the second magnetic material is lower than a magnetic permeability of the third magnetic material.

9. The vertically-wound coupling inductor according to claim 1, wherein the intermediate layer is made of a non-conductive material, and the non-conductive material includes at least one of organic materials containing oxygen and silicon functional groups, epoxy resin, polyimide, fiberglass materials, and ceramic materials.

10. A method for fabricating a vertically-wound coupling inductor, comprising:
performing a yellow photolithography process to form a first coil part and a second coil part;
performing a first pressing process to form an intermediate layer;
disposing the first coil part and the second coil part oppositely on two sides of the intermediate layer, so that the first coil part and the second coil part have a first gap therebetween;
placing the first coil part, the second coil part, and the intermediate layer into a mold and filling the mold with a first magnetic material to form an inductor body by performing a second pressing process;
performing a cutting process on the inductor body to expose portions of the first coil part and the second coil part;
performing an electroplating process to form a first external electrode and a second external electrode on an outer surface of the inductor body, wherein the first external electrode is connected to the first coil part, and the second external electrode is connected to the second coil part;
wherein a direction of a central magnetic field line generated by the magnetic coupling of the first coil part and the second coil part is parallel to an arrangement direction of the first external electrode and the second external electrode.

11. The method according to claim 10, wherein each of the first external electrode and the second external electrode includes a first electrode plate and a second electrode plate that are spaced apart from each other, and each of the first coil part and the second coil part includes:
a first coil pattern electrically connected to the first electrode plate through a first connection pattern;
a second coil pattern electrically connected to the second electrode plate through a second connection pattern, wherein the first coil pattern and the second coil pattern are oppositely disposed and have a second gap therebetween; and
a first connection part disposed in the second gap and connects the first coil pattern to the second coil pattern.

12. The method according to claim 11, wherein the first coil pattern is a first semi-closed ring body, and the first connection pattern extends along a first tangential direction defined at a first end of the first semi-closed ring body to connect the first end to the first electrode plate;
wherein the second coil pattern is a second semi-closed ring body, and the second connection pattern extends along a second tangential direction defined at a second end of the second semi-closed ring body to connect the second end to the second electrode plate.

13. The method according to claim 12, wherein the first tangential direction is parallel to the second tangential direction, and the first tangential direction and the second tangential direction are perpendicular to the outer surface of the inductor body.

14. The method according to claim 12, wherein the process of forming the first coil part and the second coil part further includes performing a second pressing process to form a spacer disposed in the second gap.

15. The method according to claim 14, wherein the spacer has a closed ring body similar to the first semi-closed ring body and the second semi-closed ring body.

16. The method according to claim 14, wherein the intermediate layer is made by performing the first pressing process on the second magnetic material, and the spacer is made by performing a third pressing process on the third magnetic material, and wherein the first magnetic material, the second magnetic material, and the third magnetic material are different from each other.

17. The method according to claim 16, wherein a magnetic permeability of the second magnetic material is lower than a magnetic permeability of the third magnetic material.

18. The method according to claim 10, wherein the intermediate layer is made of a non-conductive material, and the non-conductive material includes at least one of organic materials containing oxygen and silicon functional groups, epoxy resin, polyimide, fiberglass materials, and ceramic materials.

19. The method according to claim 10, wherein the process of performing the yellow photolithography process to form the first coil part and the second coil part includes:
performing a photolithography process on a substrate to form a predetermined pattern layer;
performing a deposition process to form a coil part to be formed on the predetermined pattern layer; and
removing the substrate and the predetermined pattern layer to form the first coil part and the second coil part.
